(19) United States
(12) Patent Application Publication
(10) Pub. No.: US 2015/0085682 A1
(43) Pub. Date: Mar. 26, 2015

(54) APPARATUS, METHOD AND COMPUTER-READABLE MEDIUM

(71) Applicant: FUJITSU LIMITED, Kawasaki-shi (JP)

(72) Inventor: Eiji HASEGAWA, Kawasaki (JP)

(73) Assignee: FUJITSU LIMITED, Kawasaki-shi (JP)

(21) Appl. No.: 14/474,762

(22) Filed: Sep. 2, 2014

(30) Foreign Application Priority Data
Sep. 20, 2013 (JP) 2013-196237

(51) Int. Cl. H04W 24/10

(52) U.S. Cl. CPC H04W 24/10
USPC 370/252

(57) ABSTRACT

An apparatus includes a memory; and a processor coupled to the memory and configured to: determine display configurations each of which is to be applied to displays of a plurality of relevant information each of which corresponds to each of devices, on the basis of a plurality of strength variation of signals each of which is transmitted from each of the devices.

### CROSS-REFERENCE TO RELATED APPLICATION

This application is based upon and claims the benefit of priority from the prior Japanese Patent Application No. 2013-196237 filed on Sep. 20, 2013, the entire contents of which are incorporated herein by reference.

### FIELD

The embodiments discussed herein relate to an apparatus, a method and a computer-readable medium.

### BACKGROUND

Recently, the use of wireless devices that are detected by scanning has increased along with the spread of wireless devices such as Wi-Fi (trademark) and Bluetooth (trademark). For example, a number of wireless devices are scanned when scanning for a wireless device such as a Wi-Fi access point or a Bluetooth device. Moreover, the MAC address and the like of these wireless devices are displayed as-is.

As a result, it is becoming more and more difficult for a user to correctly select the wireless device that the user wants to access from the plurality of wireless devices that are detected.

A method for displaying field intensity, for example, of a signal transmitted from a wireless device has been proposed in Japanese Patent Laid-open No. 2012-044679 as a method for indicating wireless devices.

### SUMMARY

According to an aspect of the invention, an apparatus includes a memory; and a processor coupled to the memory and configured to: determine display configurations each of which is to be applied to displays of a plurality of relevant information each of which corresponds to each of devices, on the basis of a plurality of strength variation of signals each of which is transmitted from each of the devices.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic view of a hardware configuration of a mobile terminal according to a first embodiment;

FIG. 2 is a schematic view of functional blocks of the mobile terminal according to the first embodiment;

FIG. 3 is a schematic view of a wireless device list according to the first embodiment;

FIG. 4 is a flow chart of display priority level update processing according to the first embodiment.

FIG. 5 is a flow chart of scan information display processing according to the first embodiment.

FIG. 6 is a schematic view of a positional relationship of the mobile terminal according to the first embodiment;

FIG. 7 is a schematic view of the wireless device list according to the first embodiment;

FIG. 8 is a schematic view of a device selection list according to the first embodiment.

FIG. 9 is a schematic view of a first modified example of the device selection list according to a first modified example.

FIG. 10 is a schematic view of a second modified example of the device selection list according to the first embodiment.

FIG. 11 is a schematic view of a third modified example of the device selection list according to the first embodiment.

FIG. 12 is a schematic view of a fourth modified example of the device selection list according to the first embodiment.

FIG. 13 is a schematic view of functional blocks of a mobile terminal according to a second embodiment;

FIG. 14 is a flow chart of display priority level update processing according to the second embodiment.

FIG. 15 is a schematic view of functional blocks of a mobile terminal according to a third embodiment;

FIG. 16 is a flow chart of display priority level update processing according to the third embodiment.

FIG. 17 is a schematic view of functional blocks of a mobile terminal according to a fourth embodiment;

FIG. 18 is a schematic view of a member list according to the fourth embodiment;

FIG. 19 is a flow chart of scan information display processing according to the fourth embodiment.

FIG. 20 is a schematic view of a hardware configuration of a mobile terminal according to a fifth embodiment;

FIG. 21 is a schematic view of functional blocks of a mobile terminal according to the fifth embodiment;

FIG. 22 is a schematic view of a wireless device list according to the fifth embodiment;

FIG. 23 is a flow chart of display priority level update processing according to the fifth embodiment.

### DESCRIPTION OF EMBODIMENTS

Observations by the inventor will be explained first. The field intensity of wireless signals is not limited to a wireless device nearby a user even if the field intensity of the wireless signals is strong since the field intensity is affected by the output electrical power of the wireless device. Moreover, even if the wireless device is present behind the user, the user is not able to narrow the number of wireless devices down to the desired wireless device if wireless devices are nearby the user since the field intensities of the wireless signals are strong. As described above, it is difficult to narrow down the wireless devices to the desired wireless device based on the field intensities of the wireless signals.

Provided are an information processor apparatus that is able to easily identify a desired device, a method for controlling the information processor apparatus, and a control program according to the following embodiments.

In the following embodiments, a user is able to identify a desired wireless device based on a variation in the field intensity of signals (wireless signals) transmitted from a wireless device when a mobile terminal (information processor apparatus) is brought closer to the wireless device.

That is, when the mobile terminal is brought closer to the wireless device, a change occurs in reception intensity in the mobile terminal with respect to the field intensity of the wireless signals transmitted from the wireless device. As a result, when focusing on the variation in the field intensity, which wireless device the user is bringing the mobile terminal closer to, that is, which device the user wants to access, can be identified. Therefore, in the following embodiments, the wireless device that is the transmission source of the wireless signals having the largest variation in field intensity is considered to be the wireless device that the mobile terminal is being brought closer to, that is, the wireless device that the user wants to access. While the variation in the field intensity is used in this case, variation includes the field intensity after a change in relation to the field intensity before the change, that is, the rate of change.

The principle upon which the embodiments are based will be explained.

When the distance from a mobile terminal to a wireless device grows smaller and when the effect of reflection waves of the wireless signals transmitted from the wireless device can be ignored, a field intensity P_{D} at a position away from the center of the antenna by a distance D is represented by the following equation (1) when electrical power P is applied to, for example, an isotropic antenna.

$$\begin{matrix}( Equation 1 ) & \\ {P}_{D} = \frac{AP}{4 π {D}^{2}} & ( 1 )\end{matrix}$$

A, in equation (1), is a coefficient that includes wavelength and gain. If it assumed that the gain does not change, A is a constant when the signals are transmitted at the same wavelength. The field intensity P_{D} at this time is inversely proportional to the square of the distance D from the center of the antenna.

It is assumed herein that wireless devices 1 and 2 are present at positions that are respective distances D1 and D2 (>D1) in a specific direction away from the mobile terminal. When the user brings the mobile terminal closer to the wireless devices 1 and 2 by a distance α (<D1 and D2), the distances from the mobile terminal to the wireless devices 1 and 2 are D1-a and D2-a respectively, and therefore the following equation (2) can be derived from equation (1).

$$\begin{matrix}( Equation 2 ) & \\ \frac{{P}_{D 1 - α}}{{P}_{D 1}} = \frac{{D}_{1}^{2}}{{( {D}_{1} - α )}^{2}} > \frac{{D}_{2}^{2}}{{( {D}_{2} - α )}^{2}} = \frac{{P}_{D 2 - α}}{{P}_{D 2}} & ( 2 )\end{matrix}$$

When the mobile terminal is brought closer to a wireless device according to equation (2), it can be seen that the variation in the field intensity of the wireless signals increases the closer the wireless device is to the mobile terminal, and further increases as the mobile terminal is brought closer to the wireless device. Therefore, even if a plurality of wireless devices are present in the vicinity of the mobile terminal, by bringing the mobile terminal closer to the desired wireless device, the mobile terminal is able to identify the wireless device to which the mobile terminal is being brought closer from the plurality of wireless devices based on the variation in the field intensity.

While the field intensity of wireless signals is used in the following embodiments, the embodiments are not limited as such. For example, a desired optical device may be identified based on the intensity of optical signals transmitted from the optical device.

### First Embodiment

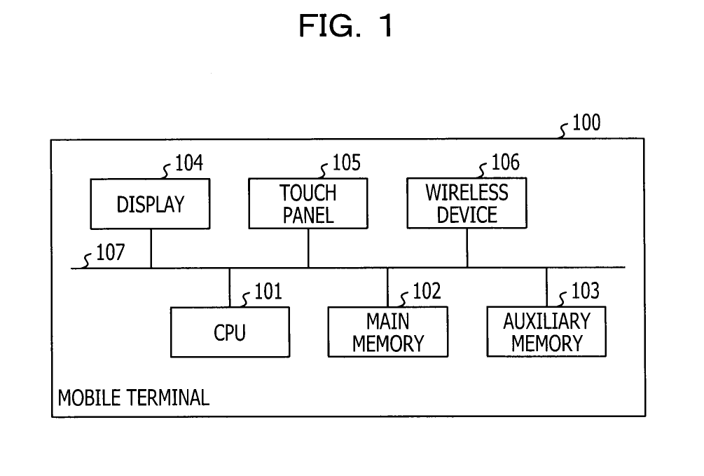

A first embodiment will be described hereinbelow with reference to FIGS. 1 to 8.

(Hardware of Mobile Terminal 1000)

FIG. 1 is a schematic view of a hardware configuration of a mobile terminal 100 according to the first embodiment. It is assumed in the present embodiment the mobile terminal 100 is a portable mobile terminal such as a smartphone or a tablet PC.

As illustrated in FIG. 1, the mobile terminal 100 is provided with a central processing unit (CPU) 101, a main memory 102, an auxiliary memory 103, a display 104, a touch panel 105, and a wireless device 106 as hardware modules. The hardware modules are interconnected through a bus 107.

The CPU 101 realizes various functions by reading various programs stored in the auxiliary memory 103 from the main memory 102 and executing the various programs read from the main memory 102. Details of the various functions are described below.

The main memory 102 stores various programs executed by the CPU 101. The main memory 102 is used as a work area by the CPU 101 and stores various types of data used for processing by the CPU 101. A random access memory (RAM) for example may be used as the main memory 102.

The auxiliary memory 103 stores various programs for operating the mobile terminal 100. In addition to application programs executed by the mobile terminal 100, for example, the various programs include an operating system (OS) which is an environment for operating the application programs. A control program according to the present embodiment is stored in the auxiliary memory 103. A non-volatile memory such as a hard disk or a flash memory may be used as the auxiliary memory 103.

The display 104 is controlled by the CPU 101 to present visual information to the user of the mobile terminal 100. The touch panel 105 is attached to the display 104. The touch panel 105 is controlled by the CPU 101 to detect contact positions of fingertips or a pen tip and the like.

The wireless device 106 is controlled by the CPU 101 to execute transmission and reception of various types of information based on Bluetooth or Wi-Fi and the like.

(Functional Blocks in Mobile Terminal 100)

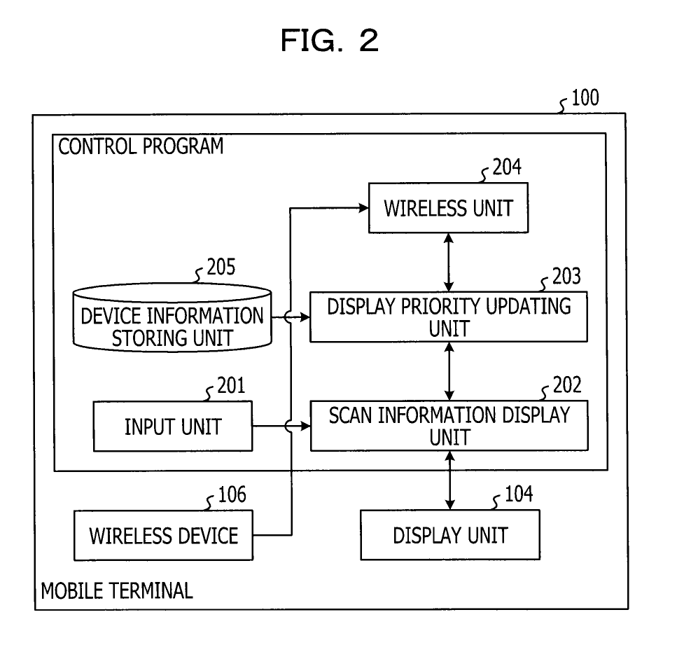

FIG. 2 is a schematic view of functional blocks of a mobile terminal according to the first embodiment.

As illustrated in FIG. 2, the mobile terminal 100 is provided with an input unit 201, a scan information display unit 202, a display priority updating unit (determining unit) 203, a wireless unit 204, and a device information storing unit 205.

The input unit 201, the scan information display unit 202, the display priority updating unit 203, the wireless unit 204, and the device information storing unit 205 are all realized by the CPU 101 reading a control program from the main memory 102 and executing the control program read from the main memory 102.

The input unit 201 recognizes a display update instruction based on, for example, an input operation on the touch panel 105 and notifies the scan information display unit 202.

The scan information display unit 202 displays information related to wireless devices as a device selection list on the display 104 based on a device display priority from the display priority updating unit 203 when triggered by the display update instruction from the input unit 201, for example. The device selection list is a list of wireless devices to be specified by the user among the wireless devices to be accessed by the mobile terminal 100. The scan information display unit 202 is configured as a determining unit along with the display priority updating unit 203.

The display priority updating unit 203 determines a display priority level of the wireless devices based on a variation in field intensity of wireless signals from the wireless unit 204. Specifically, the display priority updating unit 203 calculates the field intensity of wireless signals obtained in a current scan in relation to a field intensity of wireless signals obtained in a previous scan based on the field intensity obtained by the wireless unit 204 and the field intensity recorded in a wireless device list Ld, for each wireless device. Next, the display priority updating unit 203 determines a display priority level of the plurality of wireless devices based on the variations in the field intensities of the wireless signals. In the present embodiment, the display priority of a wireless device rises as the variation in the field intensity increases, and the display priority of a wireless device falls as the variation in the field intensity decreases.

The wireless unit 204 obtains relation information related to the wireless devices and the field intensities of wireless signals (signal intensity) based on wireless signals from a wireless device 106. The relation information includes identification information of the wireless device and the like.

The device information storing unit 205 stores the wireless device list Ld. Details of the wireless device list Ld are described below.

(Wireless Device List Ld)

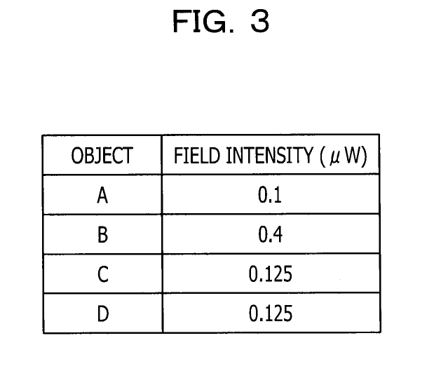

FIG. 3 is a schematic view of a wireless device list according to the first embodiment.

As illustrated in FIG. 3, the wireless device list Ld records field intensity for each wireless device. The field intensity is the field intensity of wireless signals transmitted by a wireless device and obtained by scanning. Specifically, in the record of the first row of the wireless device list Ld according to the present embodiment, a field intensity of wireless signals from a wireless device A is recorded as 0.1 μW.

(Display Priority Update Processing)

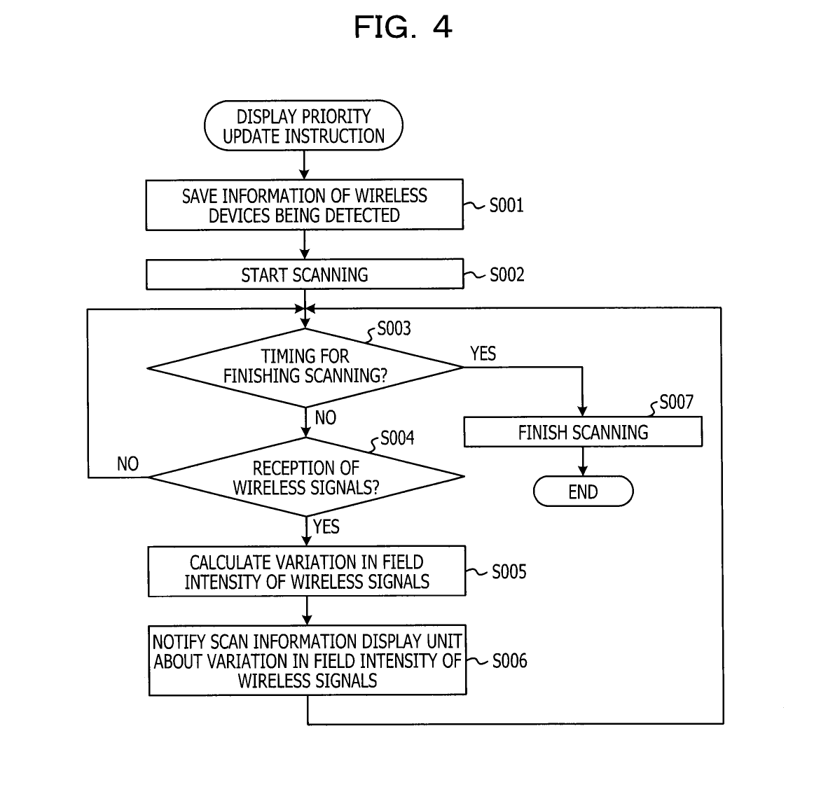

FIG. 4 is a flow chart of display priority level update processing according to the first embodiment.

As illustrated in FIG. 4, the display priority updating unit 203 starts the display priority update processing when triggered by a display priority update instruction from the scan information display unit 202.

After starting the display priority update processing, the display priority updating unit 203 records the relation information of the wireless devices being detected in the wireless device list Ld (step S001). The relation information of the wireless devices includes identification information of the wireless devices, and field intensities of the wireless signals transmitted from the wireless devices. For example, when the display priority update processing is initially started after activating the control program according to the present embodiment, the relation information of the wireless devices obtained in a first scan performed immediately after the activation of the control program, is recorded in the wireless device list Ld as the relation information of the wireless devices being detected.

Next, the display priority updating unit 203 starts scanning for wireless devices (step S002). Scanning refers to receiving wireless signals transmitted by wireless devices and obtaining the identification information of the wireless devices and the field intensities of wireless signals.

Next, the display priority updating unit 203 determines whether the present timing is timing for finishing the scanning for wireless devices (step S003). For example, the display priority updating unit 203 may determine that the present timing is the timing for finishing the scanning for wireless devices when an elapsed time from the start of the scanning for wireless devices exceeds a specific update information obtaining time period, or when a display priority update stop instruction is received from the scan information display unit 202.

When it is determined that the present timing is the timing for finishing the scanning (step S003 Yes), the display priority updating unit 203 finishes the scanning for wireless devices (step S007) and finishes the display priority update processing.

Conversely, if the it is determined that the present timing is not the timing for finishing the scanning (step S003 No), the display priority updating unit 203 determines whether wireless signals from wireless devices have been received (step S004).

If it is determined that the wireless signals have not been received at this time (step S004 No), the display priority updating unit 203 determines once again whether wireless signals from wireless devices have been received (step S003).

Conversely, if it is determined that wireless signals have been received (step S004 Yes), the display priority updating unit 203 calculates a ratio between the field intensity of wireless signals obtained in a previous scan, that is, the field intensity of the wireless signals stored in the wireless device list Ld, and the field intensity of wireless signals obtained in the current scan, that is the display priority updating unit 203 calculates a variation in the field intensity (step S005).

Next, the display priority updating unit 203 notifies the scan information display unit 202 about the variation in the field intensity of wireless signals (step S006). The scan information display unit 202 updates the device selection list based on the variation in the field intensity from the display priority updating unit 203.

Next, the display priority updating unit 203 determines once again whether the present timing is timing for finishing the scanning for wireless devices (step S003).

As described above, the display priority updating unit 203 according to the present embodiment calculates the variation in the field intensity of wireless signals for each reception of a wireless signal from a wireless device, and notifies the scan information display unit 202 about the variation in the field intensities.

(Scan Information Display Processing)

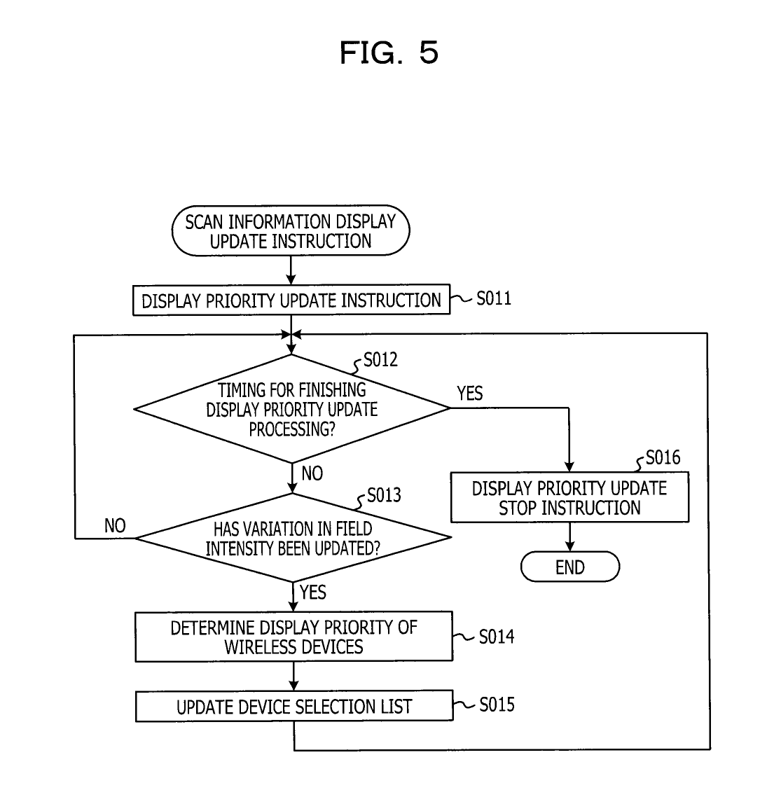

FIG. 5 is a flow chart of scan information display processing according to the first embodiment.

As illustrated in FIG. 5, the scan information display unit 202 starts the scan information display processing when triggered by a scan information display update instruction. The scan information display update instruction is, for example, generated by an input operation by the user or by the expiration of a timer.

The scan information display unit 202 displays the wireless device being detected on the display 104 as the device selection list when wireless signals are received from wireless devices before the start of the scan information display processing. At this time, the device selection list may display the identification information of a wireless device being detected based on the field intensity of wireless signals from the wireless device. For example, the identification information of the wireless device with the largest field intensity of wireless signals may be positioned at the top of the device selection list, and the identification information of the wireless devices may be sorted therebelow in order of decreasing field intensities.

After the start of the scan information display processing, the scan information display unit 202 notifies the display priority updating unit 203 about the display priority update instruction (step S011). The display priority updating unit 203 starts the display priority update processing when triggered by the display priority update instruction from the scan information display unit 202.

Next, the scan information display unit 202 determines whether the present timing is timing for finishing the display priority update processing (step S012). For example, the scan information display unit 202 may determine that the present timing is the timing for finishing the display priority update processing when an elapsed time from the start of the scanning for wireless devices exceeds specific update information obtaining time period, or when a display priority update stop instruction is received from the user.

If it is determined that the present timing is the timing for finishing the display priority update processing (step S012 Yes), the scan information display unit 202 notifies the display priority updating unit 203 about the display priority update stop instruction (step S016) and finishes the scan information display processing.

Conversely, if it is determined that the present timing is not the timing for finishing the display priority update processing (step S012 No), the scan information display unit 202 determines whether a variation in field intensity of wireless signals transmitted by any wireless device among the plurality of wireless devices, has been updated (step S013).

If it is determined that no variation in field intensity of wireless signals has been updated (step S013 No), the scan information display unit 202 determines once again whether the present timing is the timing for finishing the display priority update processing of the wireless devices (step S012).

Conversely, if it is determined that the variation in the field intensity of wireless signals has been updated (step S013 Yes), the scan information display unit 202 determines a display priority of the identification information of the wireless device based on the variation in the field intensities that have been updated, that is, the variation in the field intensities from the display priority updating unit 203 (step S014). For example, the scan information display unit 202 allocates the display priorities of “1”, “2”, “3”, “4” . . . in order of the largest variation in field intensity that have been updated. For example, the scan information display unit 202 allocates the display priority that is the highest priority to the identification information of the wireless device that has the greatest variation in field intensity, and allocates the display priority that is the lowest priority to the identification information of the wireless device that has the lowest variation in field intensity. While the display priority is derived from the variation in the field intensity in the present embodiment, the present embodiment is not limited as such and the variation in field intensity itself may be set as the display priority.

Next, the scan information display unit 202 updates the device selection list based on the display priorities of the wireless devices (step S015). As a result, even if the identification information of the wireless devices is desirably displayed based on the field intensities of the wireless signals up to the scan information display update instruction, after the scan information update is executed, the identification information of the wireless devices is re-displayed based on the variation in field intensity. The user of the mobile terminal 100 selects (specifies) the wireless device to be desirably accessed from the device selection list displayed on the display 104.

Next, the scan information display unit 202 determines once again whether the present timing is timing for finishing the display priority update processing (step S012).

(Flow of Operating Scanning for Wireless Devices)

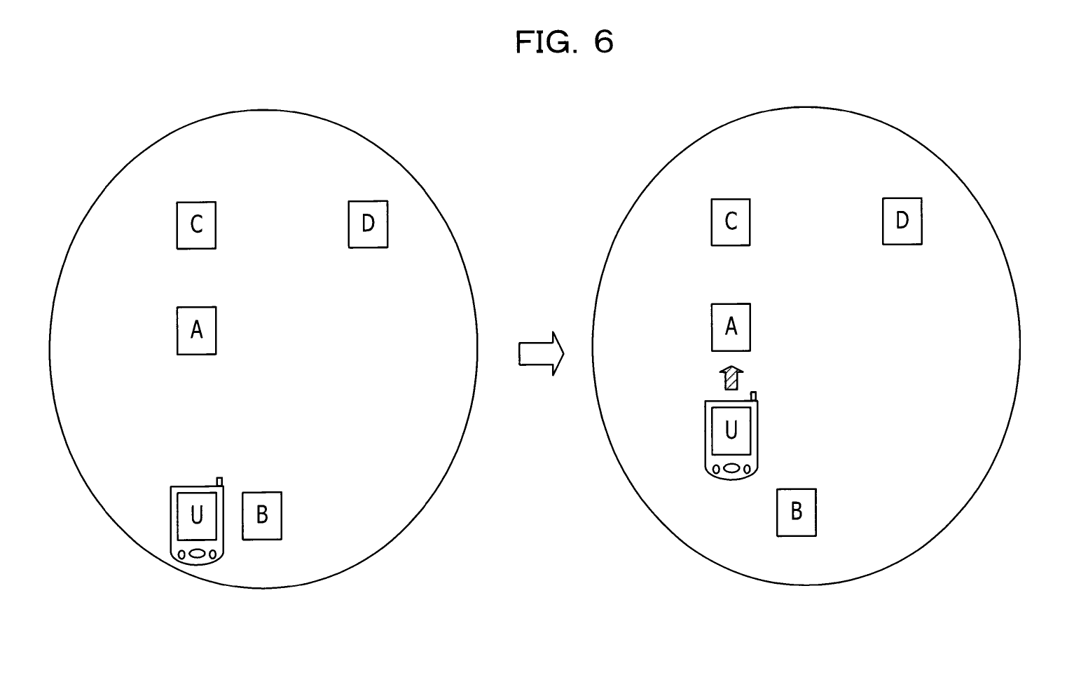

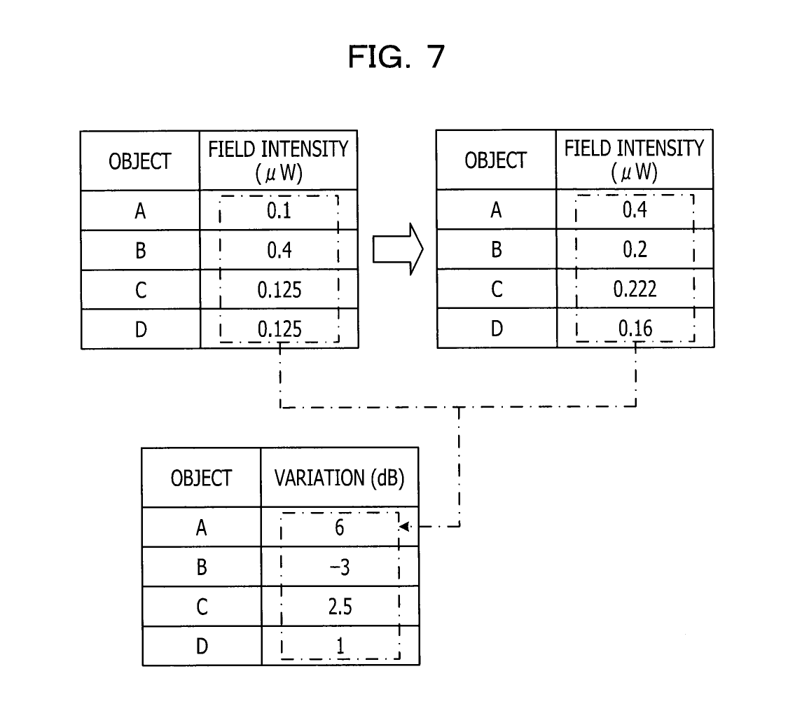

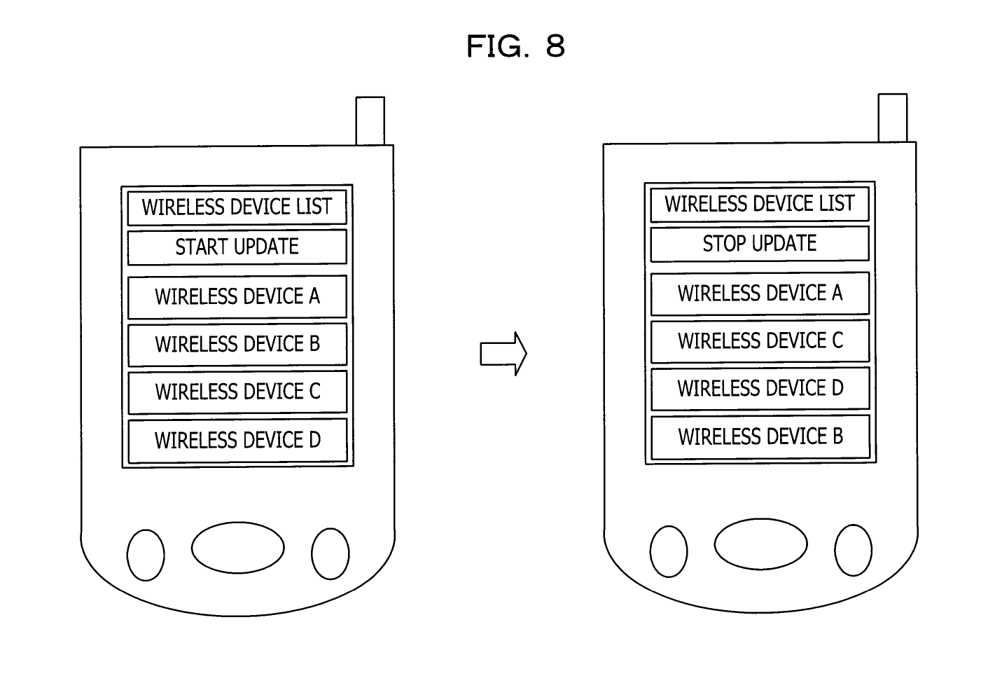

FIG. 6 is a schematic view of a positional relationship of a mobile terminal U and wireless devices A, B, C, and D according to the first embodiment. FIG. 7 is a schematic view of the wireless device list Ld according to the first embodiment. FIG. 8 is a schematic view of the device selection list according to the first embodiment.

The reference numerals A, B, C, and D in FIG. 6 are identification numerals for the wireless devices, and the reference numeral U is an identification numeral of the mobile terminal operated by the user. The mobile terminal U has the same configuration and functions as the mobile terminal 100 according to the present embodiment.

First, the user moves the user's mobile terminal U in the direction of the arrow as illustrated in FIG. 6. As a result, the distances between the wireless devices A and C from the mobile terminal U become smaller while the distance of the wireless device B from the mobile terminal U grows larger. Conversely, the distance of the wireless device D from the mobile terminal U exhibits almost no change since the wireless device D is not in line with the moving direction of the mobile terminal U.

Next, the user operates the touch panel 105 at the movement destination of the mobile terminal U to execute the scan information display update instruction. As a result, the display priority updating unit 203 in the mobile terminal U starts the display priority update processing, and as illustrated in FIG. 7, updates the wireless device list Ld of the mobile terminal U and calculates the variations in the field intensities of wireless signals transmitted from each of the wireless devices.

Here, when focusing on variation in field intensity of wireless signals, among the wireless devices A and C for which the distances from the mobile terminal U are smaller, the variation in the field intensity of wireless signals from the wireless device A that is near the mobile terminal U becomes the largest, and the variation in the field intensity of wireless signals from the wireless device C that is furthest from the mobile terminal U, becomes the second largest. Conversely, the variation in the field intensity of wireless signals from the wireless device D for which the distance from the mobile terminal U does not change very much exhibits almost no change. Moreover, the variation in the field intensity of wireless signals from the wireless device B for which the distance from the mobile terminal U grows larger, becomes smaller. That is, the order from the largest of the variations in field intensities is wireless device A, wireless device C, wireless device D, and wireless device B.

As a result, the scan information display unit 202 in the mobile information terminal U sets the display priority of the wireless device A to level 1 (highest priority), the display priority of the wireless device C to level 2, the display priority of the wireless device D to level 3, and the display priority of the wireless device B to level 4 (lowest priority) based on the variations in the field intensities from the display priority updating unit 203.

As a result, the scan information display unit 202 in the mobile information terminal U displays the wireless device with the highest priority in a position that is easy for the user to search which in the present embodiment is at the top of the device selection list as illustrated in FIG. 8.

The user of the mobile terminal U is able to easily find the identification information of the wireless device that the user wants to access, that is, the identification information of the wireless device to which the user brings the mobile terminal U closer, from the device selection list in which the identification information of a plurality of wireless devices is displayed.

As described above, according to the present embodiment, the mobile terminal is able to preferentially display the identification information of a wireless device that the user wants to access, due to the user merely bringing the user's mobile terminal 100 closer to the wireless device that the user wants to access. As a result, the user is able to easily select the desired wireless device even if a plurality of wireless devices are present around the user.

The scan information display unit 202 according to the present embodiment changes the order of the identification information of the wireless devices displayed in the device selection list based on the display priority of the wireless devices, and thus the user is able to easily select the identification information of the wireless device the user wants to access. However, the present embodiment is not limited as such. For example, various display formats may be used as illustrated in the device selection lists according to the following first to third modified examples.

### First Modified Example

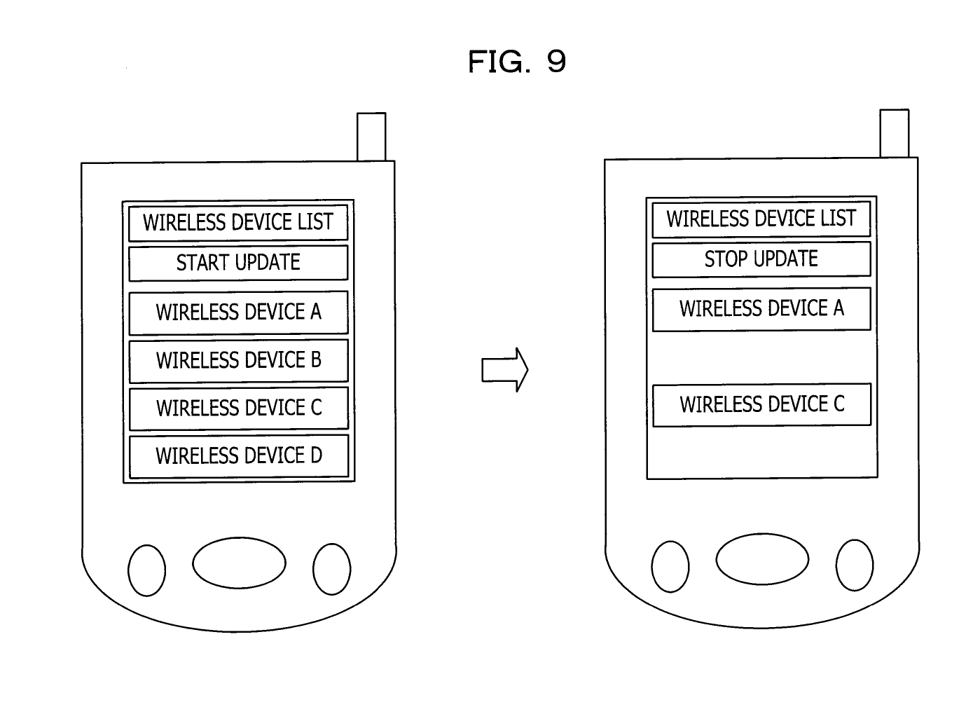

FIG. 9 is a schematic view of a first modified example of a device selection list according to a first modified example.

The scan information display unit 202 according to the first modified example omits from the device selection list the display of the identification information of a wireless device presumed to be a wireless device that the user does not want to access. For example, since a wireless device with a variation in the field intensity of the wireless signals equal to or less than 1 dB is presumed to be a wireless device that the user does not want to access, the scan information display unit 202 according to the first modified example omits that wireless device from the device selection list. As a result, only the wireless devices A and C are displayed in the device selection list in the first modified example as illustrated in FIG. 9. As a result, the user is able to select the desired wireless device more easily.

### Second Modified Example

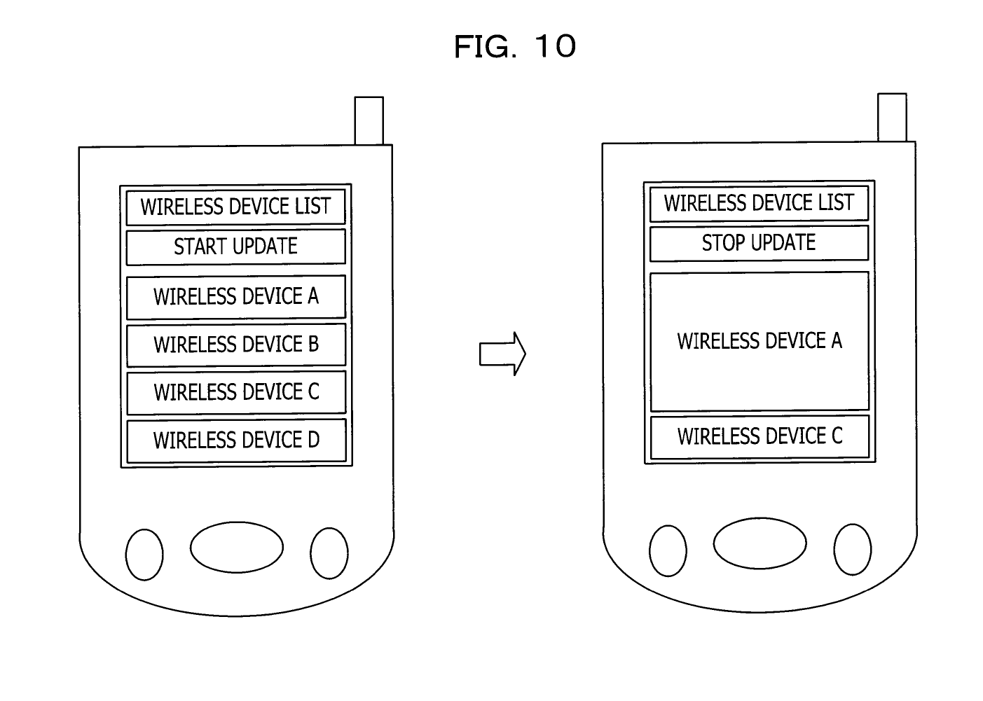

FIG. 10 is a schematic view of a second modified example of the device selection list according to the first embodiment.

The scan information display unit 202 according to the second modified example not only displays the selection of the wireless device according to the first modified example, but furthermore enlarges the display size of the identification information of the wireless device presumed to be the desired wireless device based on the variation in the field intensity of wireless signals. As illustrated in FIG. 10, the display size of the identification information of the wireless device A that has the largest variation in the field intensity of wireless signals is enlarged more than the display size of the identification information of the wireless device C in the modified example 2. As a result, the user is able to select the desired wireless device more easily.

### Third Modified Example

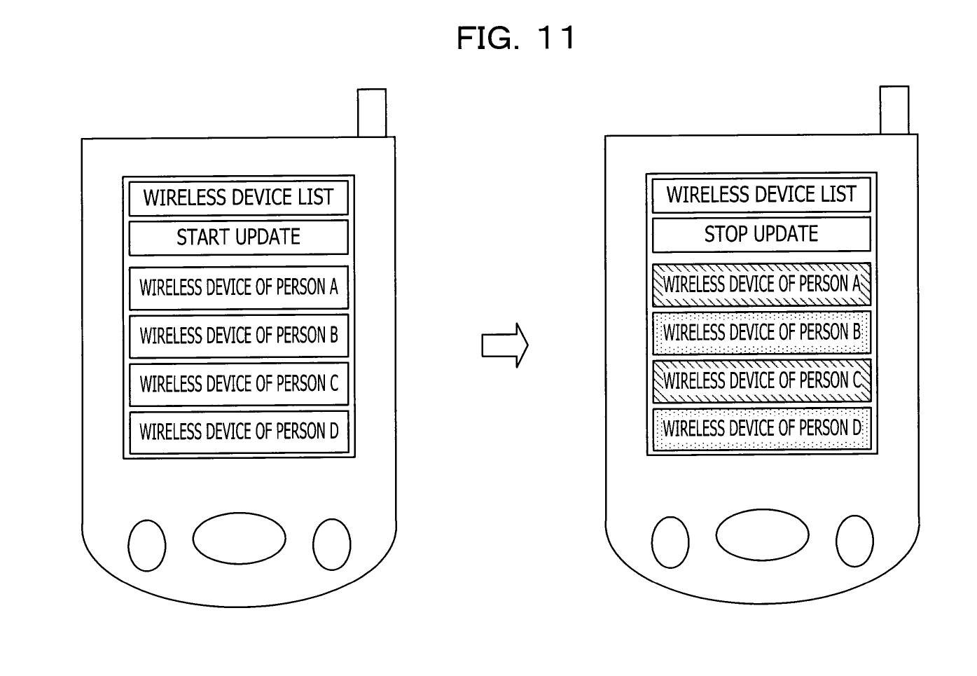

FIG. 11 is a schematic view of a third modified example of the device selection list according to the first embodiment.

The scan information display unit 202 according to the third modified example switches the display color of the identification number of the wireless device presumed to be the wireless device the user wants to access with the display color of the identification number of the wireless device presumed to be the wireless device the user does not want to access. As illustrated in FIG. 11 in the modified example 3, the display colors of the wireless devices A and C are switched with the display colors of the wireless devices B and D having a variation in field intensity of 1 dB or less, since the wireless devices having variations in field intensity that exceed 1 dB are the wireless devices that the user wants to access. In this case, the difference in display colors is represented by a difference in hatching. A contrast in the display may also be used in place of a difference in the display color.

### Fourth Modified Example

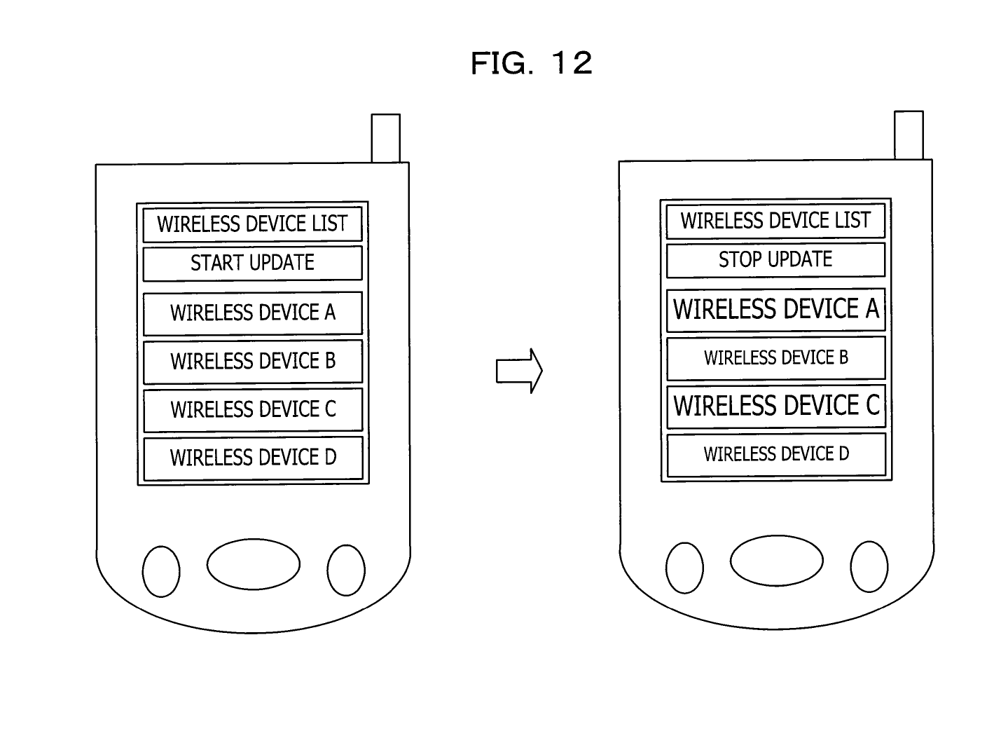

FIG. 12 is a schematic view of a fourth modified example of the device selection list according to the first embodiment.

The scan information display unit 202 according to the fourth modified example enlarges and emphasizes the text size of the identification numbers of the wireless devices presumed to be the wireless devices the user wants to access. Conversely, the text size of the identification numbers of the wireless device presumed to be wireless devices the user does not want to access is reduced and deemphasized. As illustrated in FIG. 12 in the fourth modified example, the character strings of the identification information of the wireless devices A and C are enlarged and emphasized since the wireless devices A and C are wireless devices in which the variations in the field intensity exceeds 1 dB and are presumed to be the wireless device that the user wants to access, and the character strings of the identification information of the wireless devices B and D for which the variations in the field intensity is 1 dB or less, are reduced and deemphasized.

### Second Embodiment

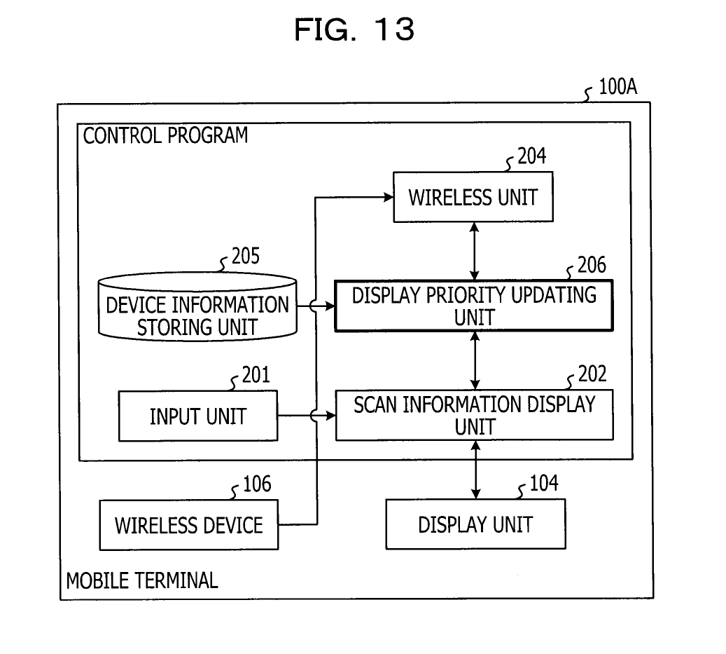

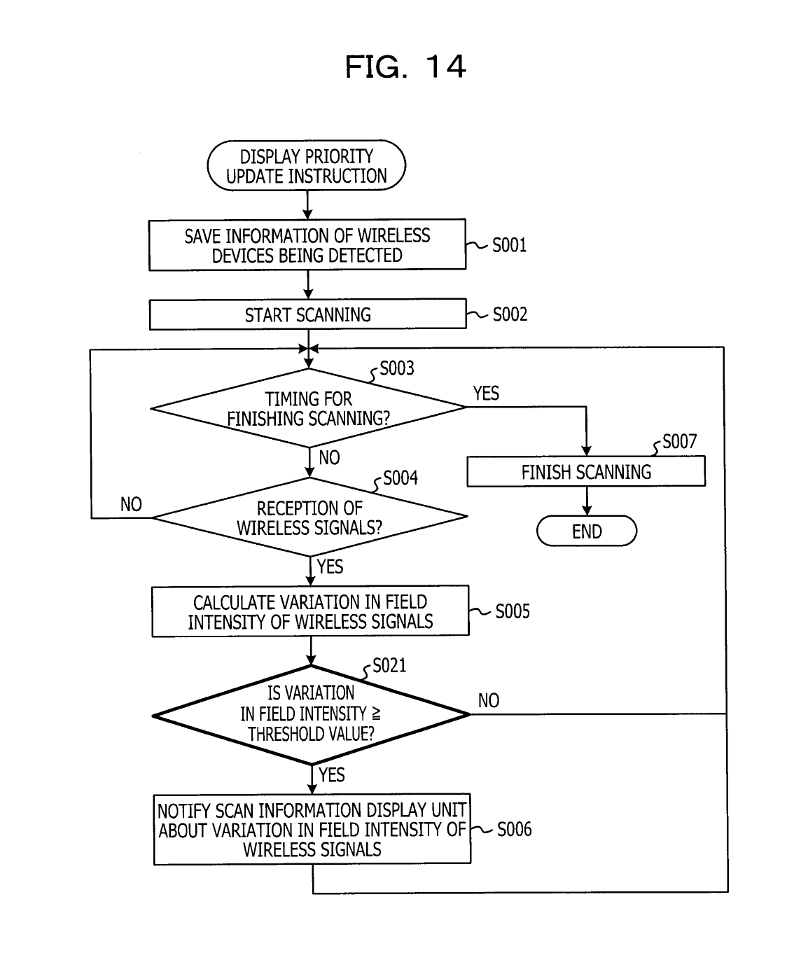

A second embodiment will be described hereinbelow with reference to FIGS. 13 and 14. Configurations, functions, and operations that are the same as those of the first embodiment will be omitted from the following explanation.

In the first embodiment, the display format of the device selection list is determined based on the variation in the field intensity of wireless signals. However, if the user does not move the mobile terminal 100 during the display priority update processing, all the variations in the field intensities of wireless signals from the wireless devices will be very small. As a result, when wireless devices having a variation in the field intensity equal to or above a threshold value are selectively displayed when applying the second modified example, all the identification information of the wireless devices is erased from the device selection list and the user becomes confused.

Accordingly, when the variation in the field intensity of wireless signals meets or exceeds a specific threshold value in the second embodiment, the variation in the field intensity of wireless signals is notified to the scan information display unit 202. As a result, the scan information display unit 202 displays the previous device selection list so long as the variation in the field intensity of wireless signals does not meet or exceed the threshold value.

(Functional Block of Mobile Terminal 100A)

FIG. 13 is a schematic view of functional blocks of a mobile terminal 100A according to the second embodiment.

As illustrated in FIG. 13, the mobile terminal 100A according to the present embodiment is provided with a display priority updating unit 206 in place of the display priority updating unit 203 according to the first embodiment.

The display priority updating unit 206 is realized by the CPU 101 reading a control program from the main memory 102 and executing the control program read from the main memory 102.

The display priority updating unit 206 notifies the scan information display unit 202 about the variation in the field intensity only if the variation in the field intensity of wireless signals meets or exceeds a specific threshold value. The display priority updating unit 206 is configured as the determining unit along with the scan information display unit 202.

(Display Priority Update Processing)

FIG. 14 is a flow chart of display priority level update processing according to the second embodiment.

As illustrated in FIG. 14, the display priority updating unit 206 calculates the variation in the field intensity of wireless signals (step S005), and then determines whether the variation in the field intensity of wireless signals is equal to or greater than a specific threshold value (step S021).

If it is determined that the variation in the field intensity is not equal to or greater than the threshold value at this time (step S021 No), the display priority updating unit 206 determines whether the current timing is the timing for finishing the scanning for wireless devices (step S003).

Conversely, if it is determined that the variation in the field intensity equals or exceeds the threshold value (step S021 Yes), the display priority updating unit 203 notifies the scan information display unit 202 about the variation in the field intensity of wireless signals (step S006). The scan information display unit 202 updates the display format of the device selection list based on the variation in the field intensity from the display priority updating unit 206.

As described above, the device selection list is updated if it is determined that the variation in the field intensity is equal to or greater than the threshold value. As a result, all of the identification information of the wireless devices is not erased from the device selection list even if the user does not move the mobile terminal 100A during the display priority update processing.

### Third Embodiment

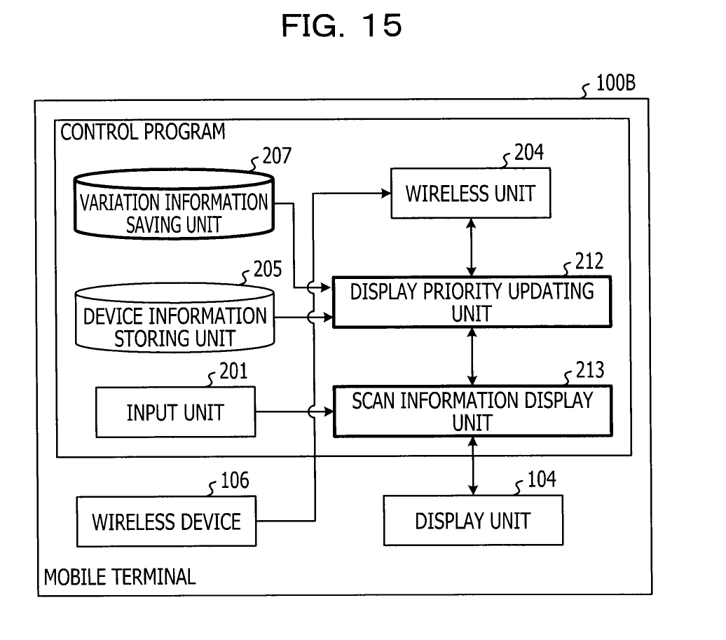

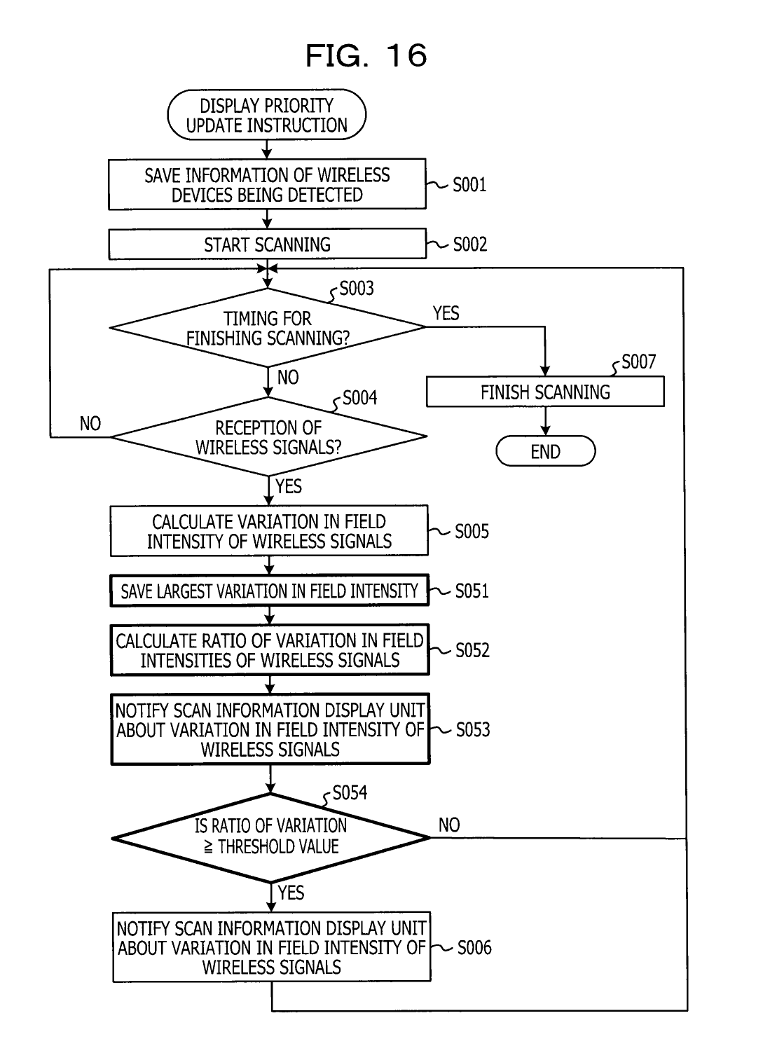

A third embodiment will be described hereinbelow with reference to FIGS. 15 and 16. Configurations, functions, and operations that are the same as those of the first embodiment will be omitted from the following explanation.

In the third embodiment, a determination is made as to whether to update the device selection list based on a ratio of the variation in the field intensity of wireless signals from the respective wireless devices in relation to the maximum variation in the field intensity among a plurality of variations in the field intensities of wireless signals.

(Functional Block of Mobile Terminal 100B)

FIG. 15 is a schematic view of functional blocks of a mobile terminal 100B according to the third embodiment.

As illustrated in FIG. 15, the mobile terminal 100B according to the present embodiment is provided with a display priority updating unit 212 and a scan information display unit 213 in place of the display priority updating unit 203 and the scan information display unit 202, and is further provided with an variation information saving unit 207 in contrast to the mobile terminal 100 according to the first embodiment.

The display priority updating unit 212, the scan information display unit 213, and the variation information saving unit 207 are all realized by the CPU 101 reading a control program from the main memory 102 and executing the control program read from the main memory 102.

The display priority updating unit 212 notifies the scan information display unit 202 about the variation in the field intensity only if the variation in the field intensity of wireless signals meets or exceeds a specific threshold value. The wireless device with the largest variation in the field intensity of wireless signals is identified among the wireless devices detected after the start of the display priority update processing, and the largest variation in the field intensity is saved in the variation information saving unit 207. Moreover, the display priority updating unit 212 calculates a ratio between the variation in the field intensity of the wireless signals saved in the variation information saving unit 207 and the variation in the field intensity of wireless signals transmitted from each of the wireless devices. The display priority updating unit 212 is configured as the determining unit along with the scan information display unit 202.

The scan information display unit 213 determines whether to update the device selection list based on the ratio of the variation in the field intensity of wireless signals from the display priority updating unit 212. If the ratio of the variation in the field intensities is less than the specific threshold value, the device selection list is not updated even if a variation in field intensity is received from the display priority updating unit 212.

The variation information saving unit 207 saves the largest variation in the field intensity among the variations in the field intensities of the wireless signals detected after the start of the display priority update processing.

(Display Priority Update Processing)

FIG. 16 is a flow chart of display priority level update processing according to the third embodiment.

As illustrated in FIG. 16, the display priority updating unit 212 calculates the variation in the field intensity of wireless signals (step S005), and then identifies the wireless device that has the largest variation in the field intensity of wireless signals among the wireless devices detected after the start of the display priority update processing, and saves the largest variation in the field intensity in the variation information saving unit 207 (step S051).

Next, the display priority updating unit 212 calculates a ratio of the variation in the field intensities of wireless signals from each of the wireless devices saved in the variation information saving unit 207, in relation to the largest variation in the field intensity (step S052). Specifically, the display priority updating unit 212 uses the following equation (3) to calculate the ratio of the variation in the field intensity.

$$\begin{matrix}( Equation 3 ) & \\ Ratio = \frac{{P}_{dev}}{{P}_{max}} & ( 3 )\end{matrix}$$

Pₘₐₓ represents the largest variation in the field intensity, and P_{dev} represents the variation in the field intensities of each of the wireless devices in equation (3).

If the user does not move the mobile terminal 100B during the display priority update processing, the largest variation in the field intensity, which is the denominator in equation (3), grows smaller. As a result, even if the variation in the field intensities of wireless signals from each of the wireless devices, which is the numerator in equation (3), is small, the ratio of the variation in the field intensity does not become too small. When the user brings the mobile terminal 100B closer to the wireless devices, while the variation in the field intensity of wireless signals from the wireless device to which the mobile terminal 100B is brought closer increases, the variations in the field intensities of the wireless signals from the wireless devices to which the mobile terminal 100B is not brought closer remain small and the ratio of the variation in the field intensities decreases.

Next, the display priority updating unit 212 notifies the scan information display unit 213 about the ratio of the variation in the field intensity (step S053). The scan information display unit 213 updates the device selection list only when the ratio of the variation in the field intensity is received from the display priority updating unit 212.

Next, the display priority updating unit 212 determines whether the ratio between the variations in the field intensities of wireless signals from each of the wireless devices and the largest variation in the field intensity of the wireless signals is equal to or greater than a specific threshold value (step S054).

If it is determined that the ratio of the variations in the field intensities is not equal to or greater than the threshold value at this time (step S054 No), the display priority updating unit 212 determines whether the current timing is the timing for finishing the scanning for wireless devices (step S003).

Conversely, if it is determined that the ratio of the variation in the field intensity is equal to or greater than the specific threshold (step S054 Yes), the display priority updating unit 212 notifies the scan information display unit 202 about the display priority of the identification information of the wireless device for which the ratio of the variation in the field intensity is determined as equal to or greater than the threshold value (step S006). The scan information display unit 213 updates the device selection list based on the priority display of the identification information of the wireless device from the display priority updating unit 212 when the ratio of the variation in the field intensity is received from the display priority updating unit 212.

As described above according to the present embodiment, the display of the identification information of the wireless devices is maintained so long as the ratio of each of the variations in the field intensities of the wireless signals in relation to the largest variation in the field intensity of the wireless signals, does not fall below the threshold value. As a result, a situation is avoided in which no identification information of any of the wireless devices is displayed due to the user not moving the mobile terminal 100B.

### Fourth Embodiment

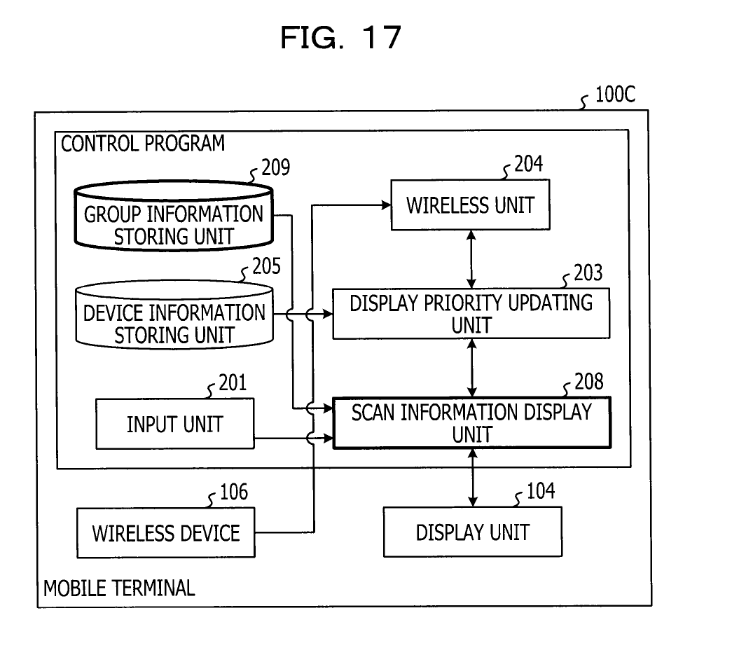

A fourth embodiment will be described hereinbelow with reference to FIGS. 17 to 19. Configurations, functions, and operations that are the same as those of the first embodiment will be omitted from the following explanation.

Only the identification information of the wireless devices is displayed in the device selection list in the first embodiment. Conversely, identification information of a group that a wireless device belongs to is displayed in the device selection list in the fourth embodiment.

(Functional Block of Mobile Terminal 100C)

FIG. 17 is a schematic view of functional blocks of a mobile terminal 100C according to the fourth embodiment.

As illustrated in FIG. 17, the mobile terminal 100C according to the present embodiment is provided with a scan information display unit 208 in place of the scan information display unit 202 according to the first embodiment, and is further provided with a group information storage unit 209 in contrast to the mobile terminal 100 according to the first embodiment.

The scan information display unit 208 and the group information storage unit 209 are all realized by the CPU 101 reading a control program from the main memory 102 and executing the control program read from the main memory 102. The scan information display unit 208 is configured as a determining unit along with the display priority updating unit 203.

The scan information display unit 208 obtains group information of the wireless devices for which the variation in the field intensity is updated and calculates a member average of the variation in the field intensity of the wireless signals for each group. Moreover, the scan information display unit 208 determines a display format of the wireless devices and the groups to be displayed in the device selection list based on the variation in the field intensity from the display priority updating unit 203 and the member average of the variation in the field intensity calculated for each group.

The group information storage unit 209 stores a member list Lm. Details of the member list Lm are described below.

(Member List Lm)

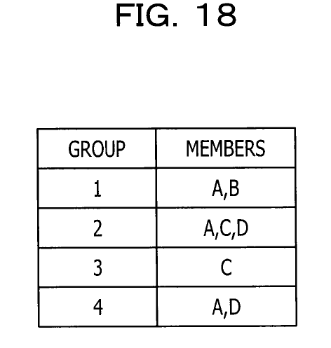

FIG. 18 is a schematic view of a member list Lm according to the fourth embodiment.

As illustrated in FIG. 18, the member list Lm stores each group and the members that belong to each group. Specifically, the wireless devices A and B are recorded as members of a group 1 in the first row in the member list Lm according to the present embodiment. The wireless devices may belong to a plurality of groups. For example, the wireless device A belongs to groups 1, 2, and 4.

(Scan Information Display Processing)

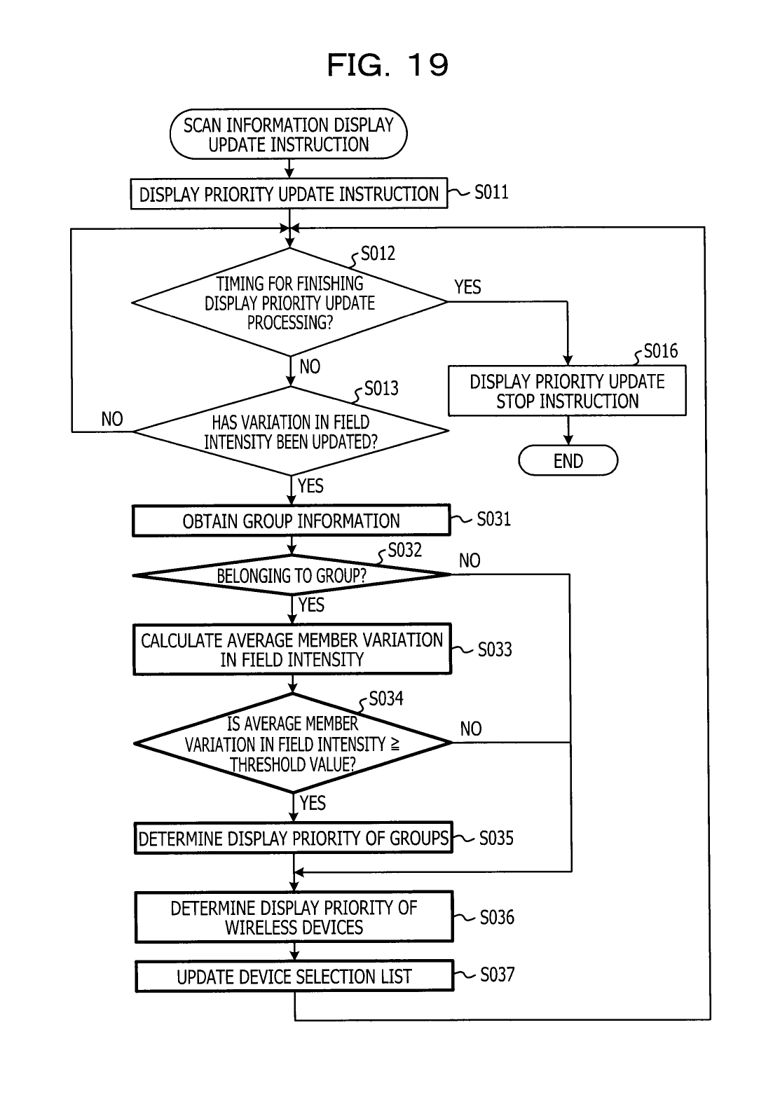

FIG. 19 is a flow chart of scan information display processing according to the fourth embodiment.

As illustrated in FIG. 19, when it is determined that the variation in the field intensity has been updated (step S013 Yes), the scan information display unit 208 obtains the member list Lm from the group information storage unit 209 (step S031).

Next, the scan information display unit 208 determines whether the wireless device that is the transmission source of the wireless signals for which the variation in the field intensity has been updated, belongs to any of the groups based on the member list Lm (step S032).

If a determination is made that the wireless device does not belong to any of the groups at this time (step S032 No), the scan information display unit 208 determines the display priority of the identification information of the wireless device based on the variation in the field intensity from the display priority updating unit 203 (step S036).

Conversely, if a determination is made that the wireless device does belong to a group (step S032 Yes), the scan information display unit 208 calculates an average value of the variations in the field intensities, that is, the average value of the variations in the field intensities of the devices that belong to the group for each group that contains a wireless device that is the transmission source of wireless signals for which the variation in the field intensity has been updated (step S033).

Next, a determination is made as to whether the member average of the variation in the field intensity is equal to or greater than a specific threshold value (step S034).

If a determination is made that the member average of the variation in the field intensity is not equal to or greater than the threshold value at this time (step S034 No), the scan information display unit 208 determines the display priority of the identification information of the wireless devices based on the variation in the field intensity from the display priority updating unit 203 (step S036).

Conversely, if a determination is made that the member average of the variation in the field intensity is equal to or greater than the threshold value at this time (step S304 Yes), the scan information display unit 208 determines the display priority of the groups based on the member average of the variations in the field intensities (step S035). For example, if the wireless device that the user wants to access belongs to a plurality of groups, the display priority is increased for the group with the largest member average of the variation in the field intensity. This is because it is presumed that a group with a higher member average of the variation in the field intensity is a group that the user wants to access.

Next, the scan information display unit 208 determines the display priority of the identification information of the wireless device based on the variation in the field intensity from the display priority updating unit 203 (step S036).

Next, the scan information display unit 208 updates the device selection list based on the display priority of the wireless devices and the display priority of the groups (step S037). However, if the display priority of the groups is not determined, the scan information display unit 208 updates the device selection list based on the display priority of the wireless devices.

As described above according to the present embodiment, when the member average of the field intensity of the wireless signals from a wireless device that is a member of a group to which wireless devices belong is equal to or greater than a threshold value, the identification information of the group as well as the identification information of the wireless device are displayed in the device selection list. As a result, the user is able to select altogether all the wireless devices that are members of a group.

Moreover, a display format of a group is determined based on a member average of the variations in the field intensities of wireless signals in each group according to the present embodiment. As a result, even if a wireless device belongs to a plurality of groups, the group with the largest member average of the variation in the field intensity, that is, the group that the user actually wants to access, may be indicated to the user.

### Fifth Embodiment

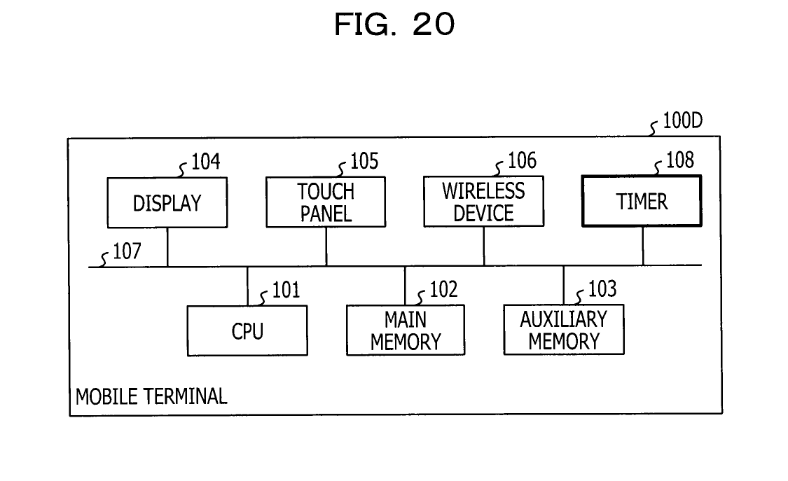

A fifth embodiment will be described hereinbelow with reference to FIGS. 20 to 23. Configurations, functions, and operations that are the same as those of the first embodiment will be omitted from the following explanation.

A variation in the field intensity of wireless signals is calculated in the first embodiment based on the field intensity of wireless signals detected in a previous scan, and the field intensity of wireless signals detected in the current scan. Accordingly in the fifth embodiment, assuming a case in which wireless signals are received any number of times during scanning, the variation in the field intensity of wireless signals is calculated based on, for example, the field intensity of wireless signals detected within a recent certain time period and the most recent (current) field intensity of wireless signals.

(Hardware of Mobile Terminal 100D)

FIG. 20 is a schematic view of a hardware configuration of a mobile terminal 100D according to the fifth embodiment.

As illustrated in FIG. 20, the mobile terminal 100D according to the fifth embodiment is further provided with a timer 108 in contrast to the first embodiment. The timer 108 is interconnected with the hardware modules through the bus 107.

(Functional Block of Mobile Terminal 100D)

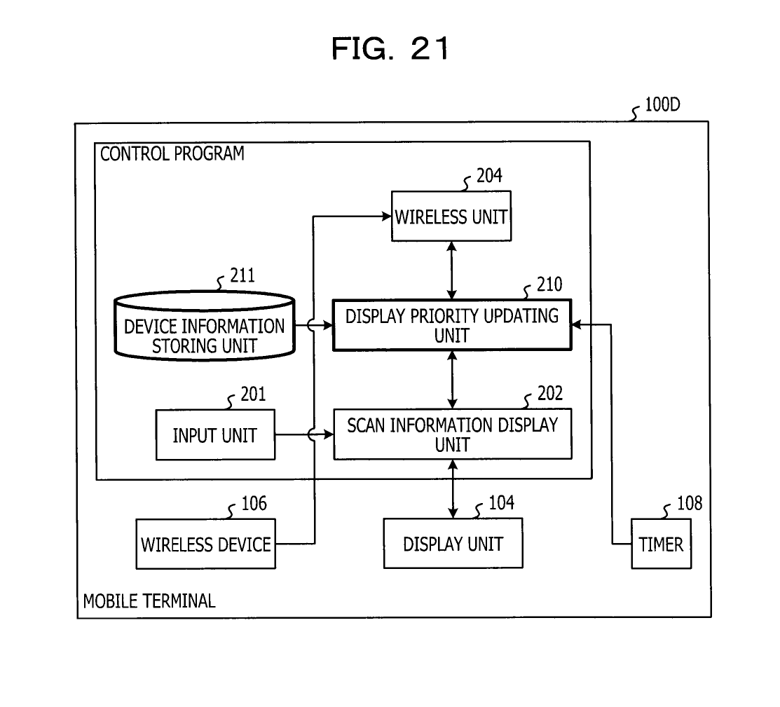

FIG. 21 is a schematic view of functional blocks of the mobile terminal 100D according to the fifth embodiment.

As illustrated in FIG. 21, the mobile terminal 100D according to the present embodiment is provided with a display priority updating unit 210 in place of the display priority updating unit 203 according to the first embodiment, and provided with a device information storage unit 211 in place of the group information storage unit 209.

The display priority updating unit 210 is realized by the CPU 101 reading a control program from the main memory 102 and executing the control program read from the main memory 102.

The display priority updating unit 210 determines the display priority of wireless devices based on a wireless device list Ldm stored in the device information storage unit 211 and time information from the timer 108. The display priority updating unit 210 is configured as the determining unit along with the scan information display unit 202.

The device information storage unit 211 stores the wireless device list Ldm. Details of the wireless device list Ldm are described below.

(Wireless Device List Ldm)

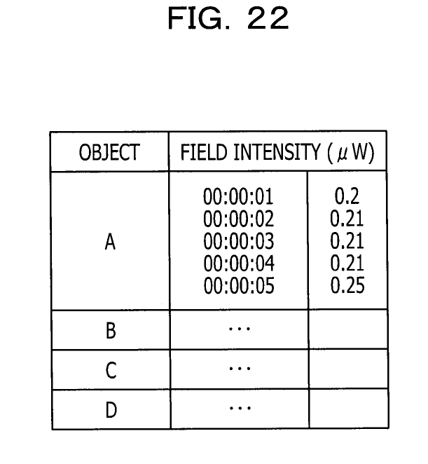

FIG. 22 is a schematic view of the wireless device list Ldm according to the fifth embodiment.

As illustrated in FIG. 22, the wireless device list Ldm according to the present embodiment records a plurality of field intensities with different obtaining times for each wireless device. For example, the field intensities 0.2 μW, 0.210N, 0.21 μW, 0.21 μW, and 0.25 μW at respective obtaining times of 1 sec, 2, sec, 3 sec, 4 sec, and 5 sec as field intensities of wireless signals from the wireless device A in the first record in the wireless device list Ldm according to the present embodiment.

(Display Priority Update Processing)

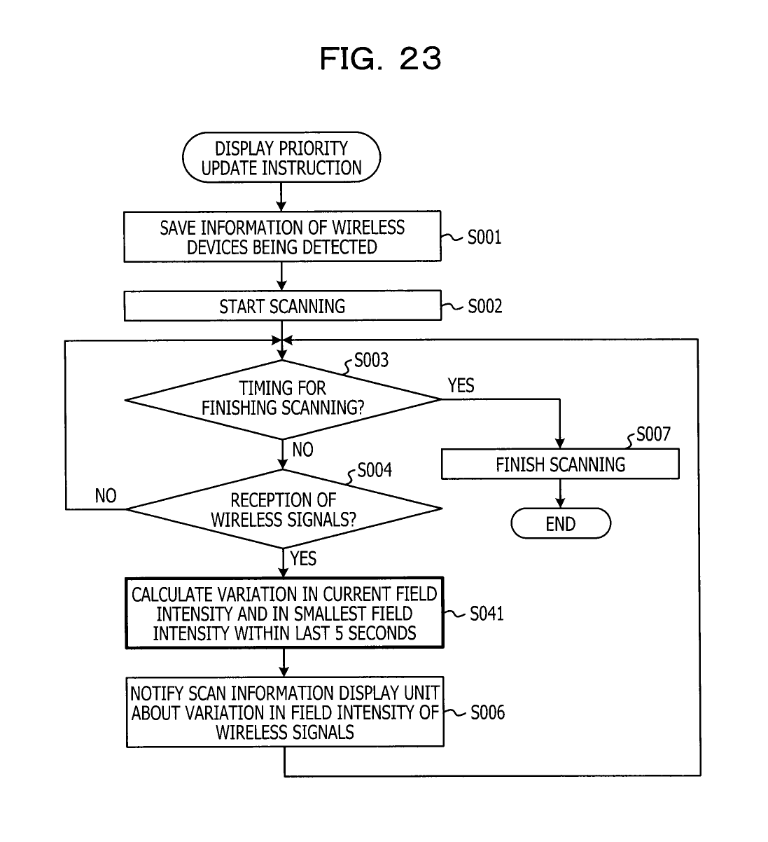

FIG. 23 is a flow chart of display priority level update processing according to the fifth embodiment.

As illustrated in FIG. 32, when it is determined that wireless signals have been received (step S004 Yes), the display priority updating unit 210 calculates the variation in the field intensity of the wireless signals based on the smallest field intensity and the most recent field intensity among the field intensities of wireless signals recorded within the last 5 seconds in the wireless device list Ldm (step S041).

Next, the display priority updating unit 210 notifies the scan information display unit 202 about the variation in the field intensities of the wireless signals (step S006).

As described above according to the present embodiment, the variation in the field intensities of the wireless signals is calculated based on the lowest field intensity among the field intensities of the wireless signals within the last 5 seconds instead of the field intensities of the wireless signals obtained in the previous scan. As a result, the device that the user wants to access, that is the wireless device to which the mobile terminal 100D is brought closer, can be identified more reliably without being affected by shaking and the like due to the user's movements.

While the above embodiments focus on the variation in the field intensity of wireless signals from wireless devices, the access point of a wireless local area network (LAN) or a Bluetooth device and the like may be used for the wireless device.

When an access point is used in place of a wireless device, the wireless device 106 mounted in the mobile terminal 100 is a Wi-Fi module, and service set identifiers (SSID) and received signal strength indicators (RSSI) for each access point are recorded in the wireless device list Ld. The SSID corresponds to the identification information of a wireless device and the RSSI corresponds to the variation in the field intensity of wireless signals.

When the wireless device is a Bluetooth device, the wireless device 106 mounted in the mobile terminal 100 is also a Bluetooth device and the SSIDs and the RSSIs for each Bluetooth device are recorded in the wireless device list Ld.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus comprising:
a memory; and
a processor coupled to the memory and configured to:
determine display configurations each of which is to be applied to displays of a plurality of relevant information each of which corresponds to each of devices, on the basis of a plurality of strength variation of signals each of which is transmitted from each of the devices.

2. The apparatus of claim 1, wherein
the processor is configured to determine the display configurations on the basis of the plurality of strength variation by determining the display configurations on the basis of the comparison between the plurality of strength variation.

3. The apparatus of claim 1, wherein
the processor is further configured to update former display configurations each of which is determined on the basis of strengths of the signals by the display configurations each of which is determined on the basis of the plurality of the strength variation.

4. The apparatus of claim 1, wherein
the processor is further configured to determine, as the display configurations, whether the relevant information are displayed, display position of the relevant information, display order of the relevant information, display size of the relevant information, display color of the relevant information, display contrast of the relevant information, character size of the relevant information, or character thickness of the relevant information.

5. The apparatus of claim 1, wherein
the devices are radio devices, and
the signals each of which is transmitted from the radio devices are radio signals.

6. A method comprising:
determining display configurations each of which is to be applied to displays of a plurality of relevant information each of which corresponds to each of devices, on the basis of a plurality of strength variation of signals each of which is transmitted from each of the devices.

7. A non-transitory computer-readable medium including a program, which when executed by a computer, causes the computer to execute a process comprising:
determining display configurations each of which is to be applied to displays of a plurality of relevant information each of which corresponds to each of devices, on the basis of a plurality of strength variation of signals each of which is transmitted from each of the devices.
